(19) United States
(12) Patent Application Publication
(10) Pub. No.: US 2007/0107919 A1
(43) Pub. Date: May 17, 2007

(54) GUIDED POWER TOOL AND METHOD FOR OPERATING A GUIDED POWER TOOL

(76) Inventors: Andreas Strasser, Rudersberg (DE); Erhard Hoffmann, Solothurn (CH); Dietmar Hahn, Gerlingen (DE)

Correspondence Address: STRIKER, STRIKER & STENBY, 103 EAST NECK ROAD, HUNTINGTON, NY, 11743, US

(21) Appl. No.: 11/619,281

(22) Filed: Jan. 3, 2007

Related U.S. Application Data
(62) Division of application No. 11/103,262, filed on Apr. 11, 2005.

(30) Foreign Application Priority Data
Apr. 14, 2004 (DE) 10 2004 017 939.5

(51) Int. Cl. B25B 21/02

(52) U.S. Cl. 173/1; 173/2

(57) ABSTRACT

The present invention is based on a method for operating a guided power tool (10), in particular an electric power tool, with a rotatably and/or percussively driven insert tool (36), whereby the insert tool (36) is driven into a work piece (34) in a work process.

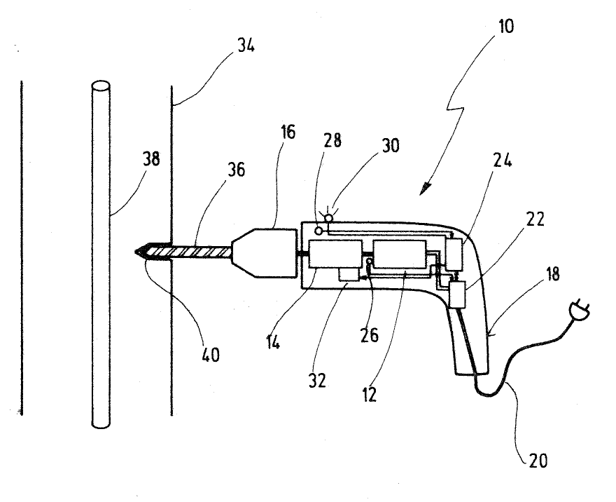

It is proposed that at least one measured signal detected at the power tool (10) during the work process is evaluated to derive a property of the work piece (34) located in the working direction of the Insert tool (36), and the power tool (10) is operated in accordance with the property. A guided power tool is also proposed.

### BACKGROUND OF THE INVENTION

The present invention is based on a guided power tool and a method for operating a guided power tool.

Hand-guided power tools, in particular electric power tools, are used to drive an insert tool, e.g., a drill, in a work piece, e.g., a wall, whereby the insert tool can be driven in a percussive manner or a rotating manner with or without percussion. In this process, the power tools do not take into account material, structure-specific properties of the material, or foreign objects such as pipes or cables that can be embedded in the material. If a foreign object of this type is damaged by the insert tool, damage can result and the operator can even be endangered.

Furthermore, position—finding devices are used—known examples are metal detection devices, “stud finders” and universal position-finding devices, for example—to locate objects such as electrical lines or pipes embedded in the wall. For an operator of a power tool it is complex and cumbersome, however, to investigate a wall for the presence of embedded objects before drilling.

### SUMMARY OF THE INVENTION

It is proposed that at least one measured signal detected at the power tool during the work process is evaluated to derive a property of the work piece located in the working direction of the insert tool, and that the power tool is operated in accordance with the property. A property of the work piece of this nature is its internal composition, in particular. Accordingly, a “property of the work piece” is understood to be a variable that is directly detectable from the outside, preferably objects embedded in the interior such as cables or pipes. A composition of the work piece involving layers of different material having different hardnesses is also preferably understood to be a property of the work piece. Another preferably understood property of the work piece is the fact that cavities or a potential opening are located in the work piece, into which the insert tool could break through. “Working direction” is understood to mean the direction in which machining progress takes place, e.g., a drilling direction. The presence of embedded objects, openings and the like results in machining problems when an embedded object comes in contact with the insert tool or the insert tool breaks through into an opening.

The method according to the present invention enables, in a simple manner, the early detection of machining problems of this type, in particular the detection of objects embedded in the work piece, e.g., pipes or cables. Likewise, a change in the structure of the work piece can be detected as work progresses, and the power tool can adapt accordingly.

It is favorable to carry out detection and evaluation repeatedly during the work process. It is particularly favorable to carry out detection and evaluation permanently during the work process. The continual monitoring of suitable measured signals by an evaluation unit during the work process enables reliable detection of the inner condition of the work piece. The information obtained in this manner can be used to control or regulate the power tool in an optimal manner or to provide an operator with machining instructions or warning signals.

If the power tool automatically adapts to the property of the work piece, damage to the work piece and/or an object embedded in it, or the power tool itself, can be avoided. Furthermore, operating comfort can be improved while good work progress is made. If the intention is to drill through tiles attached to a wall, for example, the first step can be to start drilling gently, without percussion, using parameters suitable for tiles. If the evaluation unit then detects masonry or stone as the main structure, the power tool can then continue drilling using parameters that are suitable for the material involved, e.g., with the highest impact force and speed.

When a machining problem is detected, a warning signal can be output. A machining problem of this type can be an upcoming opening in the wall, for example, or an approach to an object embedded in the work piece, such as a pipe. An evaluation unit can detect the approach to an object of this type or an opening in the wall using the detected measured signal itself and/or a change in said measured signal. The evaluation unit preferably triggers a motor electronics unit to turn the drive motor off and/or to output a warning signal via a display unit. The display unit can output acoustic and/or optical signals. If an opening in the wall is encountered, the evaluation unit—once it detects the approach to an opening—can output a warning signal via the display unit. As the distance gets closer, the display unit can output a blinking signal with increasing frequency or an acoustic signal that increases in intensity, for example. The approach can be depicted as a distance to the opening. Furthermore, the motor electronics unit and a striking mechanism control, if present, can be advantageously triggered to reduce their rotational and percussive speed and/or the impact force, or to adapt them in a suitable manner. The same procedure can be used when a pipe is approached.

A measurement that provides useful information is possible when, in a favorable embodiment, at least one signal from the group composed of vibration, sound, torque, electric current and/or electrical voltage at the drive motor, rotational speed of the drive motor and/or of the insert tool, is detected. To derive the properties of the work piece, two or more sensor signals are preferably combined. Advantageously, suitable experiential values are stored, e.g., in tables in the evaluation unit or in the motor electronics unit, to correlate different combinations of detected measured signals with material properties of the work piece that may be present. If, during drilling in a wall, a drill comes close to an embedded pipe, for example, a frequency and/or amplitude signal from a vibration sensor that monitors the vibrations of the drill changes, since the elastic voltage waves emitted by the drill are reflected on the boundary of the object and interact with the drill again. The evaluation unit can detect and evaluate this. “Vibrations of the drill and/or insert tool” is understood to mean a motion substantially perpendicular to or located at a larger angle relative to the working direction. Likewise, sound measurements, in particular structure-borne noise measurements, or noise measurements can provide information about the interior composition of the work piece.

In a preferred embodiment of the present invention, a vibration signal of the insert tool is monitored and, if the vibration signal changes, it is analyzed with regard for an embedded object located in the working direction of the insert tool and, if an embedded object is detected, the drive of the insert tool is adjusted and/or an alarm signal is output. According to the present invention, an embedded object such as a pipe or an electrical line, or a potential opening are detected, for example, before the insert tool comes in contact with it. The object can then be allowed to continue approaching the object in a controlled manner, or it can be halted altogether.

Furthermore, a guided power tool is proposed, with which an insert tool is drivable by a drive motor located in a housing, and with which an evaluation unit is provided with which the detected sensor signals are capable of being evaluated to derive properties of the work piece. The drive motor is preferably an electric motor. Other types of drives are feasible, however, such as an internal combustion engine or a pneumatic drive. Preferably, at least one sensor is provided to detect at least one signal from the group composed of vibration, sound, torque, electric current, rotational speed. As an option, a striking mechanism control can be provided for a striking mechanism, if provided. Preferably, a common drive motor is provided for the insert tool and the striking mechanism. As an option, separate drive units can also be provided. To preferably prevent objects in a wall from being drilled or for the preferable detection of openings in the wall, a striking mechanism control is not mandatory, however, but it can be provided as an option.

The present invention is suitable, in particular, for drills, impact drills, drilling hammers, boring tools and the like. Particularly favorable is the use of the method for the predictive analysis and/or early detection of the impact of the insert tool with the object embedded in the work piece, i.e., a “pre-impact diagnosis” with a power tool.

### BRIEF DESCRIPTION OF THE DRAWINGS

Further embodiments, aspects and advantages of the present invention also result from the exemplary embodiment of the present invention shown below with reference to a drawing, independently of their description in claims and without limitation of generality.

The sole FIGURE below shows a preferred power tool in the form of a hand-guided electric power tool.

### DESCRIPTION OF THE PREFERRED EMBODIMENT

A preferred hand-guided power tool 10 is composed of a drive motor 12 located in a housing 18, the drive motor driving an insert tool 36 configured as a drill bit and retained in a detachable manner in a tool holder 16, and is further composed of a motor electronic unit 22 for controlling drive motor 12, and a striking mechanism 14. In the exemplary embodiment, striking mechanism 14 is equipped with a striking mechanism control 32, whereby striking mechanism 14 is drivable by drive motor 12, so that insert tool 36 can be driven in a percussive or rotating manner, with or without percussion. Separate drive units can also be provided for striking mechanism 14 and insert tool 36. Drive motor 12 is supplied with current via an electrical connecting cable 20. A rechargeable operating means can also be provided, as an option. A speed sensor 26 is provided on drive motor 12 to detect the rotational speed of drive motor 12.

With insert tool 36 configured as a drill, a hole 40 is drilled in a work piece 34, which is a wall. An object 38 in the form of an electrical line or a pipe is embedded in the wall; the object can come in contact with insert tool 36 if work continues in the working direction.

According to the present invention, a vibration sensor 28 is provided on the end of power tool 10 facing insert tool 36. An evaluation unit 24 is connected with motor electronics unit 22 via signal lines. Motor electronics unit 22 receives signals from rotational speed sensor 26. Evaluation unit 24 receives signals from vibration sensor 28 and, as a function of these signals, triggers a display unit 30 which, in the exemplary embodiment, is an optical indicator lamp. Furthermore, evaluation unit 24 is connected with striking mechanism control unit 32 via a signal line. As an option, evaluation unit 24 can also be identical to motor electronics unit 22.

If insert tool 36 approaches embedded object 38 in the working direction during drilling in the wall, the amplitude and/or frequency signal of the vibration signal changes in a characteristic manner. Evaluation unit 24 detects the approach to object 38 and triggers motor electronics unit 22, drive motor 12 to turn off and/or it outputs a warning signal via display unit 30. As an option, evaluation unit 24 can instead trigger striking mechanism control 32 and motor electronics unit 22 to reduce the rotational speed, percussive speed and/or impact force, and to adapt to the situation in a suitable manner.

In addition to the vibration signal, sound measurements, e.g., the evaluation of the noise or a structure-borne noise, can be used; they react with sensitivity to the internal composition of work piece 34. Furthermore, torque and/or rotational speed of drive motor 12 and/or insert tool 36 and an electric current and/or electrical voltage at drive motor 10 can also be used, and in particular, their change when embedded object 38 is approached.

1-11. (canceled)

12. A method for operating a guided power tool (10), comprising the following steps:
providing a rotatably and/or percussively driven insert tool (36), whereby the insert tool (36) is adapted to be driven into a work piece (34) in a work process;
providing an evaluation unit;
evaluating at least one measured signal detected at the power tool (10) during the work process with the evaluation unit to derive a property of the work piece (34) located in the working direction of the insert tool (36); and
operating the power tool (10) in accordance with the property.

13. The method as recited in claim 12,
wherein detection and evaluation are carried out repeatedly during the work process.

14. The method as recited in claim 12,
wherein detection and evaluation are carried out continuously during the work process.

15. The method as recited in claim 12,
wherein the power tool (10) automatically adapts to the property of the work piece (34).

16. The method as recited in claim 12,
wherein a warning signal is output when a machining problem is detected.

17. The method as recited in claim 12,
wherein at least one of the signals is detected from the group composed of vibrations, sound, torque, electric current and/or electrical voltage at the drive motor (10), a rotational speed of the drive motor (12) and/or of the insert tool (36).

18. The method as recited in claim 17,
wherein two or more signals are combined to derive the properties of the work piece (34).

19. The method as recited in claim 12,
wherein the insert tool produces a vibration signal, wherein the vibration signal of the insert tool (36) is monitored and, when the vibration signal changes, it is analyzed with regard for an embedded object located in the working direction of the insert tool (36) and, when an embedded object (38) is detected, the drive of the insert tool (36) is adjusted and/or an alarm signal is output.
